(19) United States
(12) Patent Application Publication
(10) Pub. No.: US 2008/0097665 A1
(43) Pub. Date: Apr. 24, 2008

(54) METHOD FOR THE MAINTENANCE OF APPLICATION DATA OF A VEHICLE COMPONENT OF A MOTOR VEHICLE

(75) Inventors: Helmut Bentele, Langenargen (DE); Rainer Roehrle, Weiler (DE); Bayram Keser, Friedrichshafen (DE); Siegibert Fleischer, Bad Wurzach (DE)

Correspondence Address: DARBY & DARBY P.C., P.O. BOX 770, Church Street Station, New York, NY, 10008-0770, US

(73) Assignee: ZF Friedrichshafen AG, Friedrichshafen (DE)

(21) Appl. No.: 11/877,067

(22) Filed: Oct. 23, 2007

(30) Foreign Application Priority Data
Oct. 24, 2006 (DE) 10 2006 050 003.2

(51) Int. Cl. G05D 1/00

(52) U.S. Cl. 701/36; 701/1

(57) ABSTRACT

A method for the management of application data of a vehicle component of a motor vehicle includes acquiring relevant application data for the vehicle component, an electronic control unit being associated with the vehicle component, wherein the relevant application data includes parameterization data of the electronic control unit and general data about the vehicle component. The method also includes storing the relevant application data in a binary file of the electronic control unit.

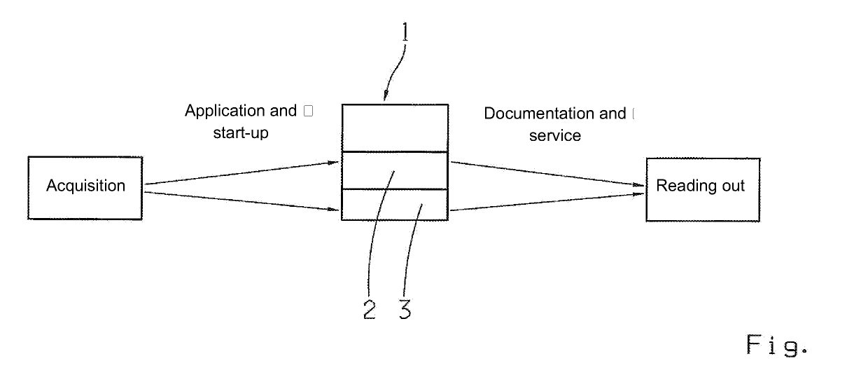

Priority is claimed to German Patent Application No. DE 10 2006 050 003.2, filed on Oct. 24, 2007, the entire disclosure of which is incorporated by reference herein.

The present invention relates to a method for the management of application data of a vehicle component of a motor vehicle.

### BACKGROUND

German patent application DE 196 43 305 A1 of the applicant, the entire disclosure of which is incorporated by reference herein, describes a method for determining the characteristic values of an automatic transmission. In the prior-art method for determining characteristic values of an electro-hydraulically controlled automatic transmission, shifting operations into the individual gear ranges of the automatic transmission are consecutively initiated on a final test bench. During the shifting transitions, the characteristic values of the automatic transmission are ascertained from a set of measured values consisting of the gear input/gear output speed, the gear input/gear output torque, and these characteristic values are subsequently stored in the form of a binary file in the gear control unit.

German patent DE 197 36 231 C2, which is incorporated by reference herein, describes a method for changing data of a control device for a vehicle in which data that controls a function of the vehicle is transmitted from a computing unit to a first storage device of a first control device, in which measured data of the vehicle is transmitted from a second storage device of the first control device to the computing unit, whereby in the first and second storage devices, at least one area is provided that is associated with a second control device. Moreover, data for the second control device is transmitted from the computing unit to the area of the first storage device, then at predefinable time intervals, data of the area of the first storage device is transferred to the second control device, whereby the second control device acquires measured data of the vehicle and writes the measured data into the area of the second control device, whereby at predefinable points in time, the first control device determines the content of the area of the first storage device, the first control device compares the content of the first area of the first storage device at the current point in time to the content of the first area of the first storage device at the preceding point in time, and the first control device transmits the content of the first area into the storage device of the second control device if the content at the current point in time differs from the content at the preceding point in time.

German patent application DE 101 10 729 A1, which is incorporated by reference herein, describes a device for electronically controlling a gear assembly, especially an automatic transmission. The prior-art device for electronically controlling a gear assembly for use in vehicles comprises a control unit connected to the drive aggregate and arranged at a spatial distance from the drive aggregate, having an identification module electrically associated with the control unit, comprising a property storage unit associated with the drive aggregate for purposes of storing at least production-related properties of controllable devices and components of the drive aggregate. Here, the identification module is arranged in the drive aggregate, especially in its housing, and it contains an operational and/or functional data storage unit for storing updated operational and/or functional data.

In the constructions or arrangements known from the state of the art, the data that is stored in a storage unit of the electronic control unit of a component is data that serves for the parametrization of the electronic control unit.

The term application data is used below to refer to the general data pertaining to the technical distribution (e.g. area of deployment of the vehicle, part list numbers, etc.) as well as the parametrization data of the electronic control unit or the data required for the function of the electronic control unit.

As a rule, the general data pertaining to the technical distribution is entered into a document or into a database and forms the basis of the compilation of the product as well as the basis of the parametrization of the data field of the electronic control unit. Whereas the parametrization data is filed or stored in a binary file of the electronic control unit of the individual component, the general data is stored in different places or in different files and is consequently not part of the binary file of the electronic control unit.

General data can be the data of the involved persons and/or departments (name, e-mail address), general vehicle data (e.g. total weight, tire size, etc.), general engine data (e.g. cubic capacity, type of control, controller characteristics, etc.), technical drawings of the components of the vehicle (e.g. gear drawings), data on the driving performance calculation and/or data on the cooling system (e.g. engine cooling constants, type of heat exchanger, thermostat values, etc.) as well as other non-technical data.

Until now, the general data was stored in at least one document or in at least one database. In this context, some of this data had to be transferred one-to-one into the data field of the control device, that is to say, into the binary file, or the data was used indirectly for the parametrization of the control device. If, for example, it had been agreed that a power take-off was to be installed, then this would be noted in a document; in order for the electronic control unit to support a power take-off, the appertaining parameters in the control device had to first be correspondingly set in the control device.

### SUMMARY OF THE INVENTION

The laborious double storage of the general data can also disadvantageously result in inconsistent data management. Moreover, the physical location where the data is stored is not the place where this data is often needed, namely, in the vehicle, and this limits the availability of the data.

An object of the present invention is to provide a method for the management of the application data of a vehicle component of a motor vehicle whose execution avoids the mentioned drawbacks known from the state of the art.

Accordingly, within the scope of the method according to the invention, it is proposed that all of the relevant application data of a vehicle component be stored in the binary file of the electronic control unit that is associated with the vehicle component. Consequently, at any point in time, all of the relevant available information is present in the binary file, thus eliminating the multiple data storage with all of the mentioned drawbacks.

As a result, thanks to the additionally available information, the data is available at all times at the vehicle, which also considerably increases the serviceability by the customer service department. For example, additional information can be stored about the individual component such as, for example, technical drawings of the component in question.

According to the invention, the different application data is acquired by means of a program and stored in the binary file of the electronic control unit of the individual component. Subsequently, the binary file is parameterized in accordance with the information, whereby additional information that does not act on parameters in the binary file (e.g. remarks, drawings) is attached to the binary file. According to the invention, the data attached to the binary file can be packed or attached directly, depending on the size and storage availability.

The data contained in the binary file can also be read out by means of the program for acquiring the data so that the application-relevant data and the general data (such as, for example, part list numbers of the wiring) are available in every vehicle. In this manner, relevant documents, for example, a malfunction specification book or an interface description, can be drawn up on every vehicle without a need for additional information.

### BRIEF DESCRIPTION OF THE DRAWING

The invention is explained in greater detail below by way of example with reference to the accompanying FIGURE.

The FIGURE shows the mode of operation of the method.

### DETAILED DESCRIPTION

The FIGURE schematically shows the binary file 1 of the electronic control unit of a vehicle component in which, according to the invention, the parametrization data 2 and the general data 3 are stored. The different application data is acquired by means of a program for the application and start-up of the component and subsequently stored in the binary file 1, whereby after the storage of the data, the binary file 1 is parameterized and whereby the data 3 or information that does not act on parameters in the binary file is attached to the binary file. Analogously to the acquisition of the data, the data can also be read out, for instance, for purposes of documentation and servicing.

What is claimed is:

1. A method for management of application data of a vehicle component of a motor vehicle, the method comprising:
acquiring relevant application data for the vehicle component, an electronic control unit being associated with the vehicle component, wherein the relevant application data includes parameterization data of the electronic control unit and general data about the vehicle component; and
storing the relevant application data in a binary file of the electronic control unit.

2. The method as recited in claim 1, wherein the general data includes at least one of general vehicle data, general engine data, data on a driving performance calculation, technical drawings of components of the vehicle and data on the cooling system.

3. The method as recited in claim 2, wherein the general vehicle data includes data relating to at least one of a total vehicle weight and a tire size.

4. The method as recited in claim 2, wherein the general engine data includes data relating to at least one of a cubic capacity of the engine, a type of engine control, and engine controller characteristics.

5. The method as recited in claim 2, wherein the data on the cooling system includes at least one of an engine cooling constant, a type of heat exchanger, and a thermostat value.

6. The method as recited in claim 1, wherein the acquiring of the application data is performed using a program and further comprising parameterized the binary file in accordance with the data, wherein additional data that does not act on parameters in the binary file is attached to the binary file.

7. The method as recited in claim 6, further comprising reading out the application data using the program so as to make the relevant application data available.
